(19) United States
(12) Patent Application Publication
(10) Pub. No.: US 2007/0211379 A1
(43) Pub. Date: Sep. 13, 2007

(54) Perpendicular magnetic head

(75) Inventors: Masaya Kato, Kawasaki (JP); Hiroshi Shirataki, Kawasaki (JP); Hideyuki Akimoto, Kawasaki (JP); Koichi Hirose, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/446,529

(22) Filed: Jun. 2, 2006

(30) Foreign Application Priority Data
Mar. 8, 2006 (JP) 2006-62238

(51) Int. Cl. G11B 5/147

(52) U.S. Cl. 360/126

(57) ABSTRACT

The perpendicular magnetic head is capable of solving the problem of pole-erasing and performing high density recording by a main magnetic pole. The perpendicular magnetic head comprises a write-head including a main magnetic pole, and the main magnetic pole is a magnetic thin film having magnetic anisotropy, in which a magnetizing direction is parallel to a recording surface of a recording medium.

### BACKGROUND OF THE INVENTION

The present invention relates to a perpendicular magnetic head, more precisely relates to a perpendicular magnetic head, which comprises a write-head having a unique main magnetic pole.

A conventional perpendicular (vertical) magnetic head of a magnetic disk drive unit is disclosed in Japanese Patent Gazette No. 2005-209244. The perpendicular magnetic head is shown in FIG. 5. The perpendicular magnetic head comprises: a read-head 8 including a lower shielding layer 5, an upper shielding layer 7 and an MR element, which is sandwiched between the shielding layers 5 and 7 and which reproduces data; and a write-head 10 including a main magnetic pole 12, a return yoke 15 and a write-gap 13 formed therebetween. A trailing shield 14 is formed at an end of the return yoke 15 so as to prevent a magnetic field generated from the main magnetic pole 12 from diffusing toward the return yoke 15. A recording coil 11 is provided between the main magnetic pole 12 and the return yoke 15.

The perpendicular magnetic head having the main magnetic pole 12 has a problem of pole-erasing, which is caused by residual magnetization of the main magnetic pole 12. With increasing recording density, recording media having great coercive forces are used. Thus, the write-head of the magnetic head is required to generate a great magnetic field, so the main magnetic pole of the write-head is made of a magnetic material having high saturation magnetic flux density (Bs). Generally, the magnetic material having high Bs has poor soft magnetic characteristics and its residual magnetization is great. Therefore, a magnetic field, which is generated by the residual magnetization of the main magnetic pole, erases data recorded in a recording medium even if no current passes through the recording coil 11. To solve the problem, a magnetic film of the write-head is made of a magnetic material having low Bs so as to restrain pole-erasing.

However, if the main magnetic pole is made of the magnetic material, which has superior soft magnetic characteristics and small residual magnetization, so as to restrain the pole-erasing, data cannot be recorded in the recording medium with high recording density due to low Bs of the main magnetic pole. Therefore, a perpendicular magnetic head, which is capable of recording data with high recording density and solving the problem of the pole-erasing, is required.

### SUMMARY OF THE INVENTION

The present invention was conceived to solve the above described problems.

An object of the present invention is to provide a perpendicular magnetic head, which is capable of solving the problem of pole-erasing and performing high density recording by a main magnetic pole.

To achieve the object, the present invention has following structures.

Namely, the perpendicular magnetic head of the present invention comprises a write-head including a main magnetic pole, and the main magnetic pole is a magnetic thin film having magnetic anisotropy, in which a magnetizing direction is parallel to a recording surface of a recording medium.

In the perpendicular magnetic head, the magnetic thin film may be formed on a base layer having specific metal lattices and has the magnetic anisotropy perpendicular to a surface of the film. And, a magnetic field may be perpendicularly applied to a surface of the magnetic thin film when the magnetic thin film is formed, so that the magnetic thin film has the magnetic anisotropy perpendicular to the surface thereof.

Another perpendicular magnetic head comprises a write-head including a main magnetic pole, and an end face of a pole end part of the main magnetic pole and a surface of the main magnetic pole are coated with a multilayered magnetic film, which is formed on a base layer made of a soft magnetic material and magnetized in a direction perpendicular to a surface of the film.

In the perpendicular magnetic head, the multilayered magnetic film may be formed by alternately layering magnetic layers, which have high magnetic flux density, and intermediate layers, and the outermost layer may be the magnetic layer. With this structure, high density recording can be performed, and the pole-erasing can be effectively restrained.

In the perpendicular magnetic head, the intermediate layer may be made of a magnetic material, which is antiferromagnetic-coupled with the magnetic layer and whose magnetizing direction is opposite to the magnetizing direction of the magnetic layer. With this structure, residual magnetization of the entire main magnetic pole can be restrained, so that the pole-erasing can be effectively restrained.

Further, the perpendicular magnetic head of the present invention comprises a write-head including a main magnetic pole, and magnetic layers, which have high magnetic flux density, and intermediate layers are alternately layered on a bottom face and both side faces of a pole end part of the main magnetic pole.

In the perpendicular magnetic head, the intermediate layer may be made of a magnetic material, which is antiferromagnetic-coupled with the magnetic layer and whose magnetizing direction is opposite to the magnetizing direction of the magnetic layer. With this structure, residual magnetization of the entire main magnetic pole can be restrained, so that the pole-erasing can be effectively restrained.

By employing the perpendicular magnetic head of the present invention, the residual magnetization of the main magnetic pole of the write-head can be directed in the direction parallel to the surface of the recording medium. Therefore, even if the residual magnetization exists, no data are erased from the recording medium by the pole-erasing.

### BRIEF DESCRIPTION OF THE DRAWINGS

Embodiments of the present invention will now be described by way of examples and with reference to the accompanying drawings, in which:

FIG. 1 is an explanation view of a main magnetic pole of the perpendicular magnetic head of a first embodiment;

FIG. 2A is a perspective view of a main magnetic pole of the perpendicular magnetic head of a second embodiment;

FIG. 2B is a sectional view of the main magnetic pole thereof;

FIG. 3A is a perspective view of a main magnetic pole of the perpendicular magnetic head of a third embodiment;

FIG. 3B is an end view of a pole end part the main magnetic pole thereof;

FIGS. 4A-4E are explanation views showing a process of producing the main magnetic pole of the third embodiment; and

FIG. 5 is a sectional view of the conventional perpendicular magnetic head.

### DETAILED DESCRIPTION OF THE EMBODIMENTS

Preferred embodiments of the present invention will now be described in detail with reference to the accompanying drawings. Note that, the present invention is characterized in that a magnetizing direction of a main magnetic pole of a write-head is parallel to a surface of a recording medium. Namely, when a magnetic film is formed on a surface of a wafer so as to make the main magnetic pole, a magnetizing direction of the magnetic film is made perpendicular to a surface of the magnetic film.

### First Embodiment

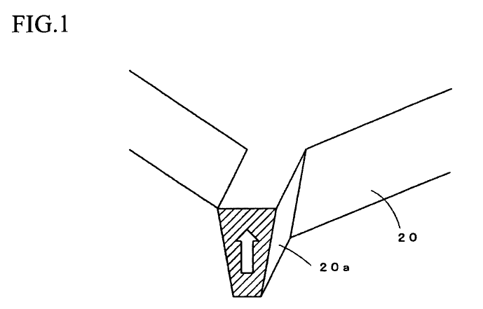

A first embodiment will be explained with reference to FIG. 1, which shows a pole end part 20a of a main magnetic pole 20 included in a write-head of a perpendicular magnetic head of the present embodiment.

The main magnetic pole 20 has the narrow pole end part 20a, which is extended toward a recording medium (not shown) and formed into an inverted trapezoid so as to prevent side track erasing.

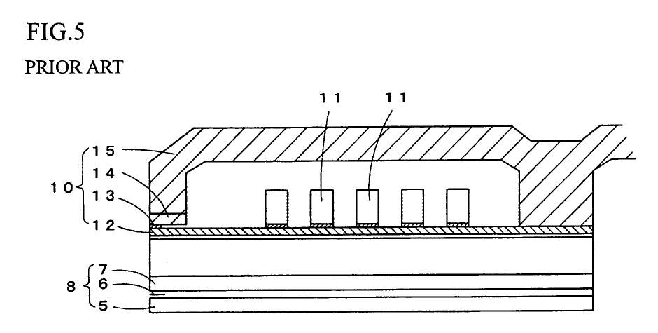

The present invention is characterized by a unique structure of the main magnetic pole 20 of the write-head of the perpendicular magnetic head. There are various types of perpendicular magnetic heads, but the present invention can be applied to all of the perpendicular magnetic heads. Note that, the basic structure of the perpendicular has been described with reference to FIG. 5, so explanation of the basic structure will be omitted. The main magnetic pole 12 shown in FIG. 5 may be used as the main magnetic pole 20 of the present embodiment.

As shown in FIG. 1, a magnetizing direction of the main magnetic pole 20 is parallel to a surface of the recording medium or perpendicular to a film surface of the main magnetic pole 20. With this structure, even if residual magnetization exists in the main magnetic pole 20, the problem of erasing data recorded in the recording medium by pole-erasing can be solved. In case that the trailing shield 14 faces the main magnetic pole 20 like the perpendicular magnetic head shown in FIG. 5, residual magnetization of the main magnetic pole 20 generates a magnetic field toward the trailing shield 14. Therefore, the influence that the residual magnetization of the main magnetic pole 20 gives to the recording medium can be reduced.

To magnetize the main magnetic pole 20 in the direction parallel to the surface of the recording medium (in the direction of an arrow shown in FIG. 1 or in the direction opposite to the arrow), the main magnetic pole 20 may be constituted by a magnetic thin film, which is made of a magnetic material having great magnetic anisotropy in the direction perpendicular to a surface of the magnetic film.

And, a material of a base layer of the magnetic thin film constituting the main magnetic film 20 may be selected so as to have the magnetic anisotropy in the direction perpendicular to the surface of the magnetic film. By forming the base layer with the selected material, which has specific metal lattices (specific lattice parameter and specific lattice planes), the magnetic thin film formed on the base layer can have the magnetic anisotropy perpendicular to the surface of the film.

Further, a magnetic field may be perpendicularly applied to the surface of the magnetic thin film when the magnetic thin film is formed, so that the magnetic thin film can have the magnetic anisotropy perpendicular to the surface thereof.

### Second Embodiment

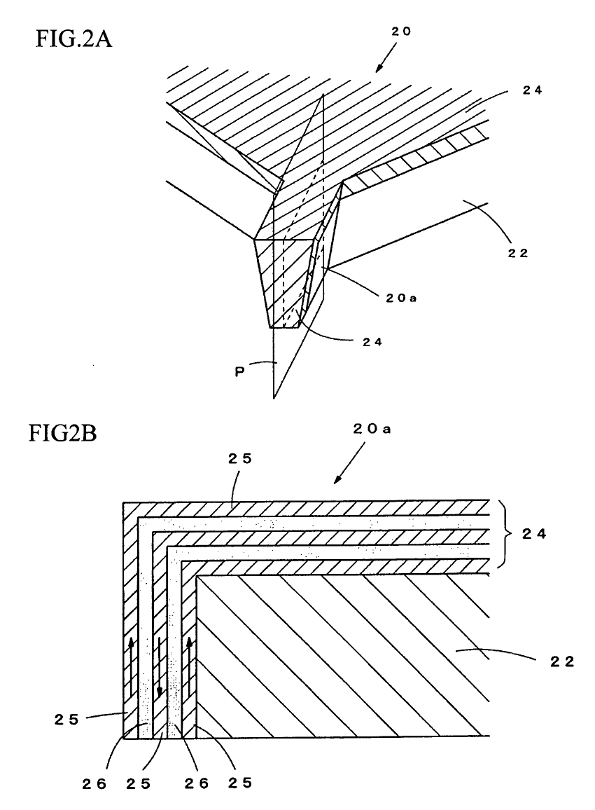

The perpendicular magnetic head of a second embodiment will be explained with reference to FIGS. 2A and 2B. In the second embodiment, a multilayered magnetic film 24 is formed on a magnetic base layer 22, which has superior soft magnetic characteristics, and magnetized in a direction perpendicular to a surface of the film 24.

In FIG. 2A, an end face of a pole end part 20a of a main magnetic pole 20, which faces a recording medium (not shown), and a surface of the main magnetic pole 20 are coated with the multilayered magnetic film 24, which is magnetized in the direction perpendicular to the surface of the film 24. The multilayered magnetic film 24 is formed by alternately layering magnetic layers 25, which have high magnetic flux density, and intermediate layers 26.

FIG. 2B is a sectional view taken along a plane P shown in FIG. 2A. The ole end part 20a is made of a material having superior soft magnetic characteristics, e.g., NiFe. As described above, the multilayered magnetic film 24 is formed by alternately layering the magnetic layers 25 and the intermediate layers 26.

The magnetic layers 25 are made of a magnetic material having high saturation magnetic flux density (Bs), e.g., FeCo. Since the magnetic layers 25 are made of the material having high Bs, the magnetic film 24 constituting the main magnetic pole 20 can have high Bs. Therefore, data can be written in the recording medium with high recording density.

When the main magnetic pole 20 writes data in the recording medium, magnetic fluxes, which are irradiated from the main magnetic pole 20 toward the recording medium, are concentrated on an upper face of the main magnetic pole 20, which faces a return yoke and a trailing shield. By forming the magnetic layers 25, which are made of the magnetic material having high Bs, on the upper face of the main magnetic pole 20, the main magnetic pole 20 is capable of effectively writing data with high recording density.

A magnetizing directions of each magnetic layer 25, which is made of the material having high Bs, e.g., FeCo, is headed for an inner part thereof. Therefore, in the pole end part 20a of the main magnetic pole 20, the magnetic layers 25 are formed parallel to an end face of the pole end part 20a facing the recording medium, so that the pole end part 20a is magnetized parallel to the end face. Namely, the end face of the pole end part 20a is magnetized in the direction parallel to the surface of the recording medium so as to restrain the pole-erasing.

A material of the intermediate layers 26 is selected from nonmagnetic materials so as to magnetize the magnetic layers 25, which sandwich the intermediate layer 26, in the opposite directions. For example, if the intermediate layers 26 are made of Ru, Pd, Rh, Cu or Cr, the magnetic layers 25, which sandwich the intermediate layer 26, are antiferromagnetic-coupled so that the magnetic layers 25 are magnetized in the opposite directions.

By magnetizing the magnetic layers 25, which sandwich the intermediate layer 26, in the opposite directions, residual magnetization of the entire multilayered magnetic film 24 can be limited so that the pole-erasing can be restrained. Further, the magnetizing direction is parallel to the end face of the pole end part 20a of the main magnetic pole 20, so that the pole-erasing can be further restrained.

As described above, if the base layer 22 of the main magnetic pole 20 is made of the material having superior soft magnetic characteristics, e.g., NiFe, the soft magnetic characteristics of the base layer 22, which constitutes a main part of the main magnetic pole 20, become major magnetic characteristics of the entire main magnetic pole 20. Therefore, even if the multilayered magnetic film 24 includes the high Bs material, the soft magnetic characteristics of the main magnetic pole 20 can be improved. Namely, the pole-erasing of the main magnetic pole 20 can be restrained by improving the soft magnetic characteristics of the main magnetic pole 20.

In the present embodiment too, the end face of the pole end part 20a is formed into an inverted trapezoid so as to prevent side track erasing.

As shown in FIGS. 2A and 2B, the pole end part 20a of the main magnetic pole 20 including the end face is coated with the multilayered magnetic film 24 by the steps of: forming the base layer film 22 of the main magnetic pole 20; patterning the base layer 22 to correspond to a planar pattern of the pole end part 20a of the main magnetic pole 20 including the end face; and alternately forming the magnetic layers 25 and the intermediate layers 26 by spattering.

In FIGS. 2A and 2B, three magnetic layers 25 are layered, but number of the magnetic layers 25 is not limited. Preferably, the outermost layer of the multilayered magnetic film 24, which is intensively used for writing action of the main magnetic pole 20, is the magnetic layer 25 having high Bs.

### Third Embodiment

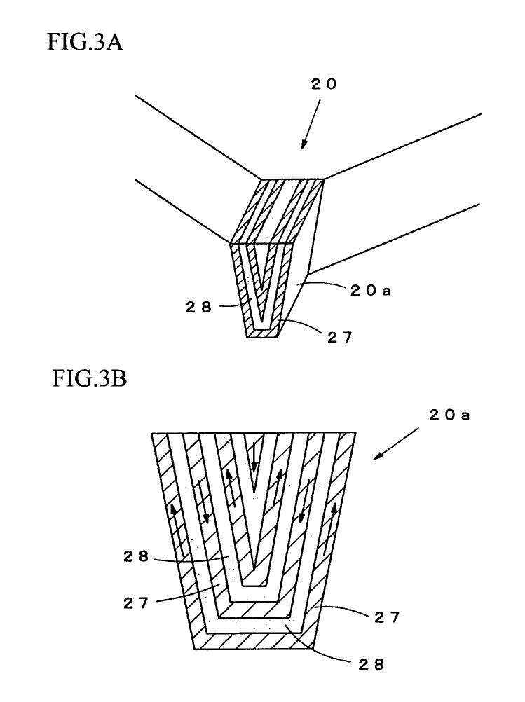

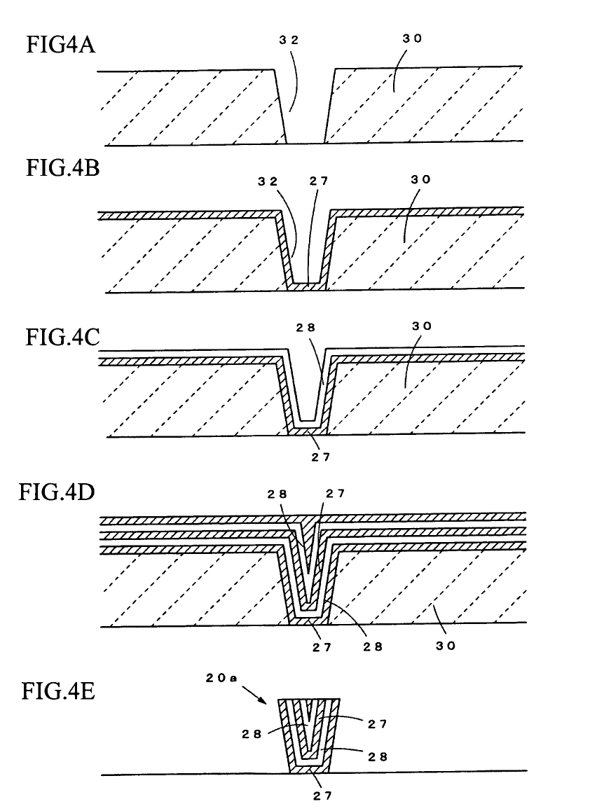

The perpendicular magnetic head of a third embodiment will be explained with reference to FIGS. 3A and 3B and FIGS. 4A-E. In the third embodiment, a pole end part 20a of a main magnetic pole 20 has a layered structure, which is constituted by magnetic layers 27 and intermediate layers 28.

FIG. 3A is a perspective view of the main magnetic pole 20 seen from the pole end part 20a side, and FIG. 3B is an end view of the layered pole end part 20a seen from an end face side.

As shown in FIG. 3B, the magnetic layers 27 and the intermediate layers 28 are alternately layered along a bottom face and side faces of the pole end part 20a, which is formed into an inverted trapezoid.

The magnetic layers 27 are thin films, and they are magnetized in the direction parallel to surfaces thereof as well as the second embodiment. Therefore, in the pole end part 20a, the magnetic layers 27 are magnetized in the direction along the side faces of the pole end part 20a. Namely, the magnetizing direction is parallel to a surface of a recording medium and perpendicular to a layering direction of a wafer (a work piece).

The intermediate layers 28 are made of a nonmagnetic material, e.g., Ru. Therefore, the magnetic layers 27, which sandwich the intermediate layer 28, are magnetized in the opposite directions, so that residual magnetization of the entire pole end part 20a can be restrained.

To enable high density recording, the magnetic layers 27 of the pole end part 20a are made of a high Bs material, e.g., FeCo. In the present embodiment, the magnetic layers 27 and the intermediate layers 28 are alternately layered so as to make a direction of the residual magnetization of the main magnetic pole 20 parallel to the surface of the recording medium. Therefore, the pole-erasing caused by the residual magnetization component can be restrained, and the main magnetic pole 20 is capable of recording data with high recording density.

FIGS. 4A-4E are explanation views showing a process of producing the main magnetic pole 20 by alternately laying the magnetic layers 27 and the intermediate layers 28.

In FIG. 4A, a surface of the wafer is coated with resist 30, then a groove 32, whose sectional shape is an inverted trapezoid corresponding to a sectional shape of the pole end part 20a of the main magnetic pole 20, is formed in the resist 30 by photolithography.

In FIG. 4B, a first layer 27 (the magnetic layer 27) is formed on an inner bottom face and inner side faces of the groove 32 by plating or spattering.

In FIG. 4C, a second layer 28 (the intermediate layer 28) is formed on the first layer 27 by plating or spattering.

In FIG. 4D, the magnetic layers 27 and the intermediate layers 28 are further alternately layered. The groove 32 is filled with the magnetic layers 27 and the intermediate layers 28, which are alternately layered.

In FIG. 4E, parts of the magnetic layers 27 and the intermediate layers 28 coating the surface of the resist 30 are removed by lift-off after the groove 32 is filled with the magnetic layers 27 and the intermediate layers 28. With this step, the pole end part 20a, in which the magnetic layers 27 and the intermediate layers 28 are alternately layered, is produced.

Note that, alumina may be used instead of the resist 30. In this case, the groove 32, whose sectional shape is formed into an inverted trapezoid, is formed with, for example, alumina RIE. Then, the magnetic layers 27 and the intermediate layers 28 are alternately layered and flattened. With this process too, the pole end part 20a, in which the magnetic layers 27 and the intermediate layers 28 are alternately layered, can be produced. In this case, the both sides of the main magnetic pole 20 are coated with alumina layers.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A perpendicular magnetic head, comprising:
a write-head including a main magnetic pole,
wherein the main magnetic pole is a magnetic thin film having magnetic anisotropy, in which a magnetizing direction is parallel to a recording surface of a recording medium.

2. The perpendicular magnetic head according to claim 1,
wherein the magnetic thin film is formed on a base layer having specific metal lattices and has the magnetic anisotropy perpendicular to a surface of the film.

3. The perpendicular magnetic head according to claim 1,
wherein a magnetic field is perpendicularly applied to a surface of the magnetic thin film when the magnetic thin film is formed, so that the magnetic thin film has the magnetic anisotropy perpendicular to the surface thereof.

4. A perpendicular magnetic head, comprising:
a write-head including a main magnetic pole,
wherein an end face of a pole end part of the main magnetic pole and a surface of the main magnetic pole are coated with a multilayered magnetic film, which is formed on a base layer made of a soft magnetic material and magnetized in a direction perpendicular to a surface of the film.

5. The perpendicular magnetic head according to claim 4,
wherein the multilayered magnetic film is formed by alternately layering magnetic layers, which have high magnetic flux density, and intermediate layers, and the outermost layer is the magnetic layer.

6. The perpendicular magnetic head according to claim 5,
wherein the intermediate layer is made of a magnetic material, which is antiferromagnetic-coupled with the magnetic layer and whose magnetizing direction is opposite to the magnetizing direction of the magnetic layer.

7. A perpendicular magnetic head, comprising:
a write-head including a main magnetic pole,
wherein magnetic layers, which have high magnetic flux density, and intermediate layers are alternately layered on a bottom face and both side faces of a pole end part of the main magnetic pole.

8. The perpendicular magnetic head according to claim 7,
wherein the intermediate layer is made of a magnetic material, which is antiferromagnetic-coupled with the magnetic layer and whose magnetizing direction is opposite to the magnetizing direction of the magnetic layer.
